(19) United States
(12) Patent Application Publication
(10) Pub. No.: US 2016/0067766 A1
(43) Pub. Date: Mar. 10, 2016

(54) 3D PRINTED INVESTMENT MOLDS FOR CASTING OF AMORPHOUS ALLOYS AND METHOD OF USING SAME

(71) Applicants: Apple Inc., Cupertino, CA (US); Crucible Intellectual Property, LLC, Rancho Santa Margarita, CA (US)

(72) Inventors: Adam A. Verreault, Rancho Santa Margarita, CA (US); Michael Deming, Trabuco Canyon, CA (US); Sean Timothy O'Keeffe, Tustin, CA (US); Glenton R. Jelbert, Foothill Ranch, CA (US); Stephanie O'Keeffe, Rancho Santa Margarita, CA (US); Jeffrey L. Mattlin, Cupertino, CA (US); Theodore A. Waniuk, Lake Forest, CA (US)

(21) Appl. No.: 14/572,126

(22) Filed: Dec. 16, 2014

Related U.S. Application Data
(60) Provisional application No. 62/047,489, filed on Sep. 8, 2014.

(51) Int. Cl. B22C 9/02; C21D 1/18; B22D 27/08; C22F 1/00; C22C 1/00; B22D 25/06

(52) U.S. Cl. CPC B22C 9/02; C22C 1/002; B22D 25/06; B22D 27/08; C22F 1/002; C21D 1/18; B33Y 10/00

(57) ABSTRACT

Described herein is a method of forming a 3D investment mold using a layer-by-layer construction (3D printing). The mold is configured for receipt of a molten alloy having a composition configured to form a bulk metallic glass (BMG) on cooling. The mold has a hollow interior between inner and outer walls. The hollow interior receives the molten alloy for molding it between the inner and outer walls of the mold. A method of casting using the 3D investment mold is also disclosed, which may include filling the mold with molten alloy, removing bubbles, quenching the molten alloy in the mold, and then removing the mold.

### CROSS REFERENCE RELATED APPLICATION(S)

This application claims priority to U.S. Provisional Patent Application No. 62/047,489, filed Sep. 8, 2014, which is hereby incorporated by reference in its entirety.

### FIELD

The described embodiments relate generally to a 3D printed mold. More particularly, the present embodiments relate to a method of making a 3D mold and a method of filling and quenching investment 3D molds for casting of amorphous alloys.

### BACKGROUND

A large portion of the metallic alloys in use today are processed by solidification casting, or investment casting, at least initially. The metallic alloy is melted and cast into a metal or ceramic mold, where it solidifies. The mold is stripped away, and the cast metallic piece is ready for use or further processing. The as-cast structure of most materials produced during solidification and cooling depends upon the cooling rate. There is no general rule for the nature of the variation, but for the most part the structure changes only gradually with changes in cooling rate. On the other hand, for the bulk-solidifying amorphous alloys the change between the amorphous state produced by relatively rapid cooling and the crystalline state produced by relatively slower cooling is one of kind rather than degree—the two states have distinct properties.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. This amorphous state can be highly advantageous for certain applications. If the cooling rate is not sufficiently high, crystals may form inside the alloy during cooling, so that the benefits of the amorphous state are partially or completely lost. For example, one risk with the creation of bulk amorphous alloy parts is partial crystallization due to either slow cooling or impurities in the raw material.

Bulk-solidifying amorphous alloys have been made in a variety of metallic systems. They are generally prepared by quenching from above the melting temperature to the ambient temperature. Generally, high cooling rates such as one on the order of 10⁵° C./sec, are needed to achieve an amorphous structure. The lowest rate by which a bulk solidifying alloy can be cooled to avoid crystallization, thereby achieving and maintaining the amorphous structure during cooling, is referred to as the “critical cooling rate” for the alloy. In order to achieve a cooling rate higher than the critical cooling rate, heat has to be extracted from the sample. Thus, the thickness of articles made from amorphous alloys often becomes a limiting dimension, which is generally referred to as the “critical (casting) thickness.” A critical thickness of an amorphous alloy can be obtained by heat-flow calculations, taking into account the critical cooling rate.

Until the early nineties, the processability of amorphous alloys was quite limited, and amorphous alloys were readily available only in powder form or in very thin foils or strips with a critical thickness of less than 100 micrometers. A class of amorphous alloys based mostly on Zr and Ti alloy systems was developed in the nineties, and since then more amorphous alloy systems based on different elements have been developed. These families of alloys have much lower critical cooling rates of less than 10³° C./sec, and thus they have much larger critical casting thicknesses than their previous counterparts. However, little has been shown regarding how to utilize and/or shape these alloy systems into structural components, such as those in consumer electronic devices. In particular, pre-existing forming or processing methods often result in high product cost when it comes to high aspect ratio products (e.g., thin sheets) or three-dimensional hollow products. Moreover, the pre-existing methods can often suffer the drawbacks of producing products that lose many of the desirable mechanical properties as observed in an amorphous alloy.

### SUMMARY

It is one aspect of this disclosure to provide a method including forming a 3D investment mold using a layer-by-layer construction for receipt of a molten alloy having a composition configured to form a bulk metallic glass (BMG) on cooling. The mold is configured to be filled with a molten amorphous alloy to form a housing of an electronic device.

Another aspect of this disclosure provides a method including filling a 3D investment mold formed by a layer-by-layer construction process with molten alloy; quenching the molten alloy in the 3D investment mold, and then removing the 3D investment mold from the quenched, molded alloy. The 3D investment mold is configured to form a bulk metallic glass (BMG) part that is part of an electronic device.

Yet another aspect of this disclosure includes a method that includes supplying molten amorphous alloy to a mold of a layer-by-layer construction, and then removing the BMG product from the mold after cooling of the molten amorphous alloy. The molten amorphous alloy supplied to the mold has a composition configured to form the bulk metallic glass (BMG) product on cooling. The mold has a cavity between two walls for receiving the molten amorphous alloy therein.

Other aspects and advantages of the present invention will become apparent from the following detailed description, the accompanying drawings, and the appended claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 provides a temperature-viscosity diagram of an exemplary bulk solidifying amorphous alloy.

FIG. 2 provides a schematic of a time-temperature-transformation (T) diagram for an exemplary bulk solidifying amorphous alloy.

FIG. 3 is a flow chart illustrating exemplary steps in a method of forming a mold using a 3D or layer by layer printing process and a method of using the mold.

FIG. 4 shows a first perspective view of an exemplary investment mold formed from 3D printing in accordance with an embodiment of this disclosure.

FIG. 5 shows a second perspective view of the exemplary investment mold of FIG. 4 in accordance with an embodiment of this disclosure.

FIG. 6 shows a third perspective view of the exemplary investment mold of FIG. 4 in accordance with an embodiment of this disclosure.

FIG. 7 shows a fourth perspective view of the exemplary investment mold of FIG. 4 in accordance with an embodiment of this disclosure.

FIG. 8 is a cross-sectional view as taken along line 8-8 in FIG. 5 of the exemplary investment mold in accordance with an embodiment of this disclosure.

FIG. 9 is a cross-sectional view as taken along line 9-9 in FIG. 4 of the exemplary investment mold in accordance with an embodiment of this disclosure.

FIG. 10 is a cross-sectional view as taken along line 10-10 in FIG. 7 of the exemplary investment mold in accordance with an embodiment of this disclosure.

FIG. 11 is a cross-sectional view that is similar to the cross section as taken along line 9-9 in FIG. 4 of the exemplary investment mold in accordance with an embodiment of this disclosure.

FIG. 12 shows an underside view at a first perspective of the exemplary investment mold of FIGS. 4-7 in accordance with an embodiment of this disclosure.

FIG. 13 shows an underside view at a second perspective of the exemplary investment mold of FIGS. 4-7 in accordance with an embodiment of this disclosure.

FIG. 14 shows a first perspective view of an exemplary BMG molded part formed using the mold of FIGS. 4-13 in accordance with an embodiment of this disclosure.

FIG. 15 shows a second perspective view of the exemplary BMG molded part formed using the mold of FIGS. 4-13 in accordance with an embodiment of this disclosure.

FIG. 16 shows a third perspective view of the exemplary BMG molded part formed using the mold of FIGS. 4-13 in accordance with an embodiment of this disclosure.

FIG. 17 shows a fourth perspective view of the exemplary BMG molded part formed using the mold of FIGS. 4-13 in accordance with an embodiment of this disclosure.

FIG. 18 shows an underside view at a first perspective of the exemplary molded part of FIGS. 14-17 in accordance with an embodiment of this disclosure.

FIG. 19 shows an underside view at a second perspective of the exemplary molded part of FIGS. 14-17 in accordance with an embodiment of this disclosure.

FIG. 20 shows an underside view at a third perspective of the exemplary molded part of FIGS. 14-17 in accordance with an embodiment of this disclosure.

FIG. 21 is a cross-sectional view as taken along line 21-21 in FIG. 15 of the exemplary molded part in accordance with an embodiment of this disclosure.

FIG. 22 is a cross-sectional view as taken along line 22-22 in FIG. 17 of the exemplary molded part in accordance with an embodiment of this disclosure.

FIG. 23 is a perspective view of the cross-section of the exemplary molded part of FIG. 22 in accordance with an embodiment of this disclosure.

FIG. 24 shows a first perspective view of the exemplary investment mold of FIGS. 4-13 with a funnel attached to its seat for a crucible tube in accordance with an embodiment of this disclosure.

FIG. 25 shows a second perspective view of the exemplary investment mold of FIGS. 4-13 with the funnel of FIG. 24 in accordance with an embodiment of this disclosure.

FIG. 26 is a cross-sectional view as taken along line 26-26 in FIG. 25 of the exemplary mold and funnel in accordance with an embodiment of this disclosure.

FIG. 27 is a cross-sectional view as taken along line 27-27 in FIG. 24 of the exemplary mold and funnel in accordance with an embodiment of this disclosure.

FIG. 28 is a cross-sectional view as taken along line 28-28 in FIG. 25 of the exemplary mold and funnel with molten alloy therein for molding in accordance with an embodiment of this disclosure.

FIG. 29 is a perspective view of the cross-section of the mold and funnel with molten alloy therein in FIG. 28 in accordance with an embodiment of this disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

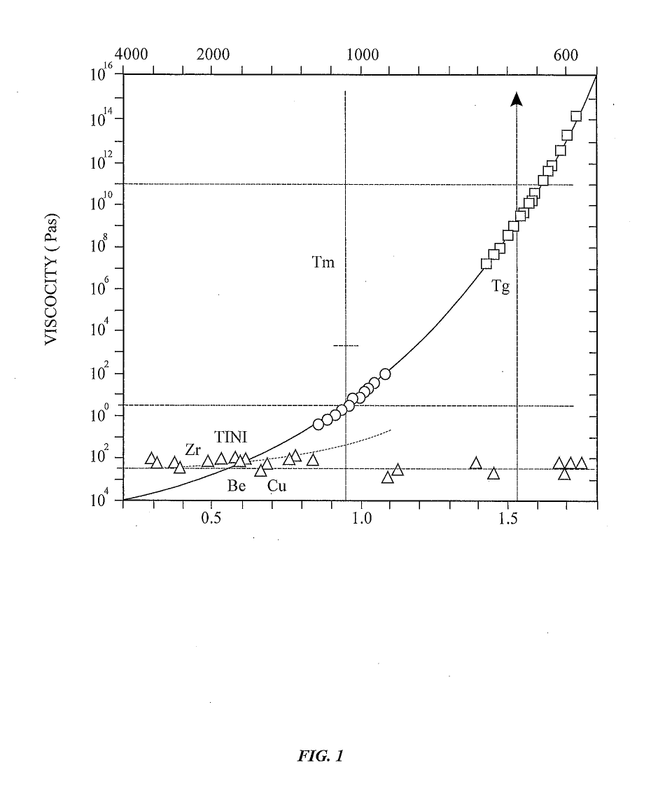

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

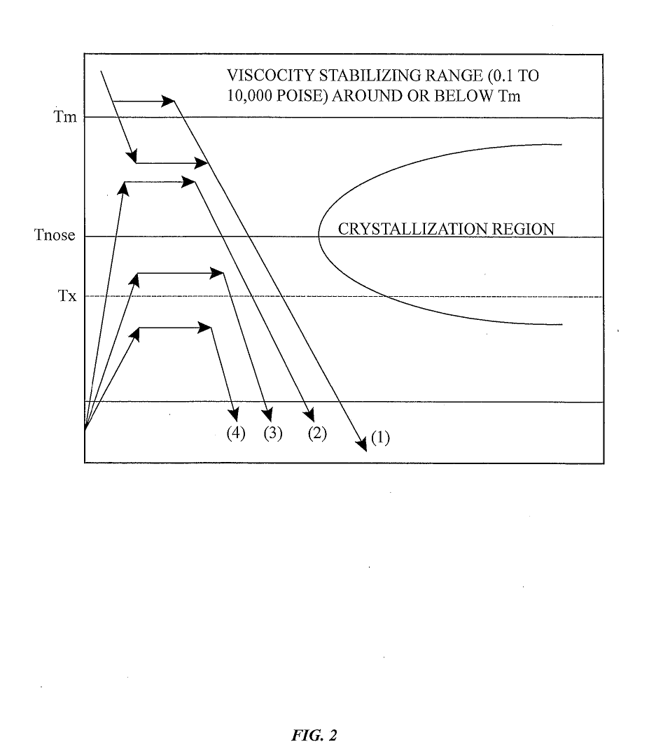

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 10¹² Pa s at the glass transition temperature down to 10⁵ Pa s at the crystallization temperature, the high temperature limit of the supercooled liquid region. Liquids with such viscosities can undergo substantial plastic strain under an applied pressure. The embodiments herein may be implemented in the liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 2, Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substantially simultaneously with fast cooling to avoid the trajectory hitting the TTT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, has sium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x,x′)= [symbol] s(x),s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)ₐ(Ni, Cu)_{b}(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1 and Table 2.

TABLE 1
Exemplary amorphous alloy compositions

| Alloy | Atm % | Atm % | Atm % | Atm % | Atm % | Atm % | Atm % | Atm % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 5 | Pt | Cu | Ag | P | B | Si | | |
| | 74.70% | 1.50% | 0.30% | 18.0% | 4.00% | 1.50% | | |

TABLE 2
Additional Exemplary amorphous alloy compositions (atomic %)

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | | |
| | 50.75% | 36.23% | 4.03% | 9.00% | | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Zr | Ti | Fe | Be | | |
| | 35.00% | 30.00% | 2.00% | 33.00% | | |
| 13 | Au | Ag | Pd | Cu | Si | |
| | 49.00% | 5.50% | 2.30% | 26.90% | 16.30% | |
| 14 | Au | Ag | Pd | Cu | Si | |
| | 50.90% | 3.00% | 2.30% | 27.80% | 16.00% | |
| 15 | Pt | Cu | Ni | P | | |
| | 57.50% | 14.70% | 5.30% | 22.50% | | |
| 16 | Zr | Ti | Nb | Cu | Be | |
| | 36.60% | 31.40% | 7.00% | 5.90% | 19.10% | |
| 17 | Zr | Ti | Nb | Cu | Be | |
| | 38.30% | 32.90% | 7.30% | 6.20% | 15.30% | |
| 18 | Zr | Ti | Nb | Cu | Be | |
| | 39.60% | 33.90% | 7.60% | 6.40% | 12.50% | |
| 19 | Cu | Ti | Zr | Ni | | |
| | 47.00% | 34.00% | 11.00% | 8.00% | | |
| 20 | Zr | Co | Al | | | |
| | 55.00% | 25.00% | 20.00% | | | |

Other exemplary ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe48Cr15Mo14Y2C15B6. They also include the alloy systems described by Fe—Cr—Mo—(Y,Ln)-C—B, Co—Cr—Mo-Ln-C—B, Fe—Mn—Cr—Mo—(Y,Ln)-C—B, (Fe, Cr, Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co, Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe80P12.5C5B2.5, Fe80P11C5B2.5Si1.5, Fe74.5Mo5.5P12.5C5B2.5, Fe74.5Mo5.5P11C5B2.5Si1.5, Fe70Mo5Ni5P12.5C5B2.5, Fe70Mo5Ni5P11C5B2.5Si1.5, Fe68Mo5Ni5Cr2P12.5C5B2.5, and Fe68Mo5Ni5Cr2P11C5B2.5Si1.5, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature Tₓ. The cooling step is carried out at rates similar to the heating rates at the heating step, and preferably at rates greater than the heating rates at the heating step. The cooling step is also achieved preferably while the forming and shaping loads are still maintained.

### Electronic Devices

The embodiments herein can be valuable in the fabrication of electronic devices (or parts thereof, e.g., a housing) using a BMG. An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blu-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

To cast such devices like these electronic devices (or parts thereof, e.g., housings), metal or ceramic molds are typically used. As previously noted, when molten materials such as BMG are processed by solidification casting or investment casting, the molten BMG alloy is added to a mold to solidify, and the mold is later stripped or removed from the part. It has been found at times that forming such metal or ceramic molds may be difficult or challenging, depending upon the complexity of the part to be molded, and the geometric shapes and locations of parts on a piece to be molded. Also, when using metals to form such molds, the ability to make horizontal walls in each of the molds without a support structure (e.g., such as a honeycomb structure) or without vertical walls spaced every few millimeters can be difficult because of the weight of the metal (e.g., it being heavy) and the possibility that such horizontal walls can collapse (e.g., the powder bed can collapse or break). Also, using horizontal walls or supports can hinder the process. For example, eliminating horizontal supports may allow for a more uniform cooling rate at the quenching step in the process. As such, different orientations and part modifications have been limited based on known methods for forming investment molds.

Traditionally, molds have been formed using a lost wax method (e.g., when forming a ceramic mold) or in a process that involves coating a (metal) mold with ceramic powder. However, the material costs might dwarf the mold costs. Further, if machining of the mold were required after its casting (e.g., machining off portions on the exterior of a steel mold), the costs are expensive for most and can be wasteful.

In accordance with an embodiment of this disclosure, 3D printing, also known as “additive manufacturing” (AM) or layer by layer processing, may be used to produce or form 3D investment molds directly from computer-generated design data (the mold as described herein is the three dimensional product formed from digital data). Such molds may be used in investment casting processes or methods. The process described herein uses 3D printing to produce a metal mold, thus sharing some of the benefits of the above-noted lost wax method while being suitable for molding amorphous metals. Generally, 3D printing uses layering techniques to build three-dimensional parts. Such parts may be formed by forming successive thin cross-sections of the desired part. The individual cross-sections are formed by bonding together adjacent grains of a granular material on a generally planar surface of a bed of the granular material. Each layer is bonded to a previously formed layer to form the desired three-dimensional article at the same time as the grains of each layer are bonded together. 3D printing can be quicker and less expensive than machining of prototype parts or production of cast or molded parts by conventional “hard” or “soft” tooling techniques, which can typically take from a few weeks to several months to manufacture, depending on the complexity of the part. Accordingly, it should be understood that throughout this disclosure any reference to 3D printing or AM or layer-by-layer processing of molds refers to any of various processes of joining materials to make one or more three-dimensional objects (i.e., to make molds for investment casting) from 3D model data or other electronic data source, through layer upon layer or additive processes in which successive layers of material are laid down under computer control (e.g., as opposed to subtractive manufacturing methodologies).

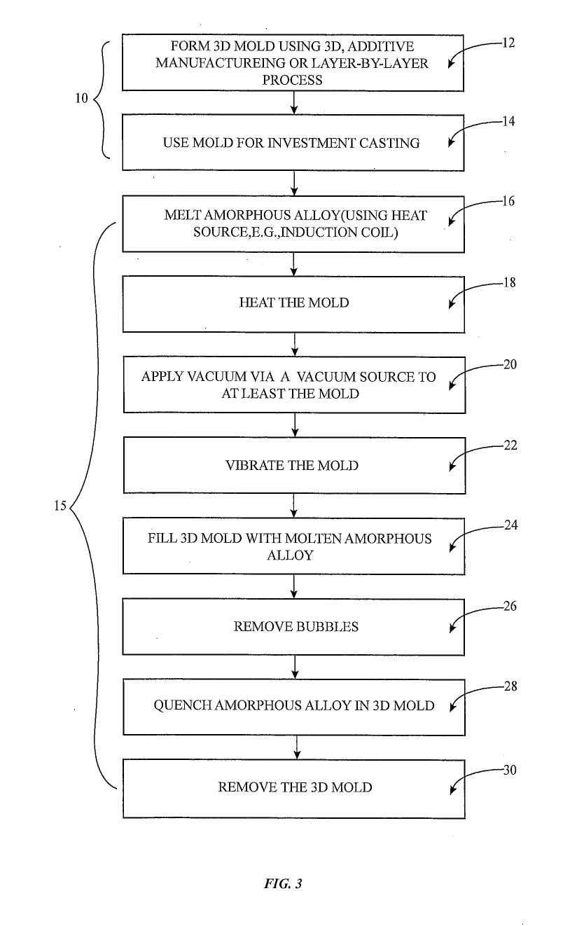

As such, as generally shown in by method 10 of FIG. 3, this disclosure provides a method 10 including forming a 3D investment mold using a 3D, additive manufacturing, and/or layer-by-layer construction process (step 12). The formed 3D mold is configured for receipt of a molten alloy (amorphous alloy) having a composition configured to form a bulk metallic glass (BMG) on cooling.

The herein disclosed 3D printed mold is, in accordance with embodiments, designed to replace permanent tooling for some applications. In an embodiment, the formed 3D mold is used for investment casting, as shown by step 14 in FIG. 3. In an embodiment, the mold is consumable.

In an embodiment, the 3D investment mold includes a hollow interior between inner and outer walls. For example, as described in greater detail below, the hollow interior is configured to receive molten alloy in order to mold the molten alloy between the inner and outer walls of the 3D formed mold. Using a 3D or layer by layer printing process enables the formation of a hollow mold, without the need of tooling or other parts (e.g., a slide, a lift) to form detailed features on the mold.

The disclosed mold may be produced from a variety of materials, and may include a single type or two or more types of materials. In accordance with one embodiment, the mold is printed using a metal. In accordance with another embodiment, the mold is printed using a ceramic. Use of a ceramic mold may have superior high-temperature mechanical properties and be more chemically inert in contact with molten amorphous alloy. In an embodiment, the type of metal or ceramic material used to print and form the mold is based on the type of molten alloy to be molded. In one embodiment, the material used to print the mold is a material that is capable of molding a molten amorphous alloy filled or poured therein, that forms into a BMG part (e.g., of an electronic device).

Three dimensional printing can be performed using a variety of machines which utilize data related to 3D CAD models, for example, to manipulate and form parts. Accordingly, the type of machine and process implemented or used to form the disclosed mold is not intended to be limiting. Further, it should be understood that other machines (including those that may be developed at a later date), that utilize a form of 3D, AM, or layer by layer processing are also envisioned as devices that may be used to form the herein disclosed mold. Also, the parts and configuration of the machine used to form the 3D mold are not intended to be limited. For example, in an embodiment, the machine may be configured to utilize a single outlet or nozzle to print one or more layers of the mold. In another embodiment, a layer of the layer-by-layer construction is deposited from any number of outlets or nozzles (including two or more outlets or nozzles). The printing material may exit from the outlet as a continuous stream or discrete droplets.

The layer by layer construction process used to form the disclosed 3D mold is not intended to be limited. For example, in an embodiment, selective laser sintering (SLS) is the additive manufacturing technique that is used to form the herein disclosed mold. SLS is a technique that uses a laser as a power source to sinter powdered material (typically metal). The laser is aimed automatically at points in space defined by a 3D model, binding the material together to create a solid structure.

In another embodiment, direct metal laser sintering (DMLS) is the additive manufacturing technique that is used to form the herein disclosed mold. DMLS is a technique that uses a laser as a power source to sinter powdered material (typically metal), and aim the laser automatically at points in space defined by a 3D model, binding the material together to create a solid structure.

SLS and DMLS processes typically continue with wiping another layer of powder after binding, and continuing the process thereafter until the part (e.g., mold) is complete.

In another embodiment, a selective laser melting (SLM) technique is used to form the disclosed mold. SLM uses 3D model data as a digital information source, and an energy or power source in the form of a high-power laser beam (e.g., ytterbium fiber laser) is used fuse fine metallic powders together. Generally, the material is fully melted into a solid homogeneous mass when using SLM (rather than sintered as in an SLS technique, for example).

In still yet another embodiment, an electron beam melting (EBM) technique is used to form the mold. EBM uses an electron beam as its energy or power source. EBM technology manufactures parts by melting metal powder layer by layer with an electron beam in a high vacuum.

Generally, 3D printing machines convert powdered metal or ceramic feedstock into a fully-dense net-shape part. In this case, a mold would be printed which has the negative features of the final desired amorphous metal part. That is, the mold is a negative for the part that is to be molded. The 3D printed mold could then be filled with amorphous metal, to form a molded part (positive).

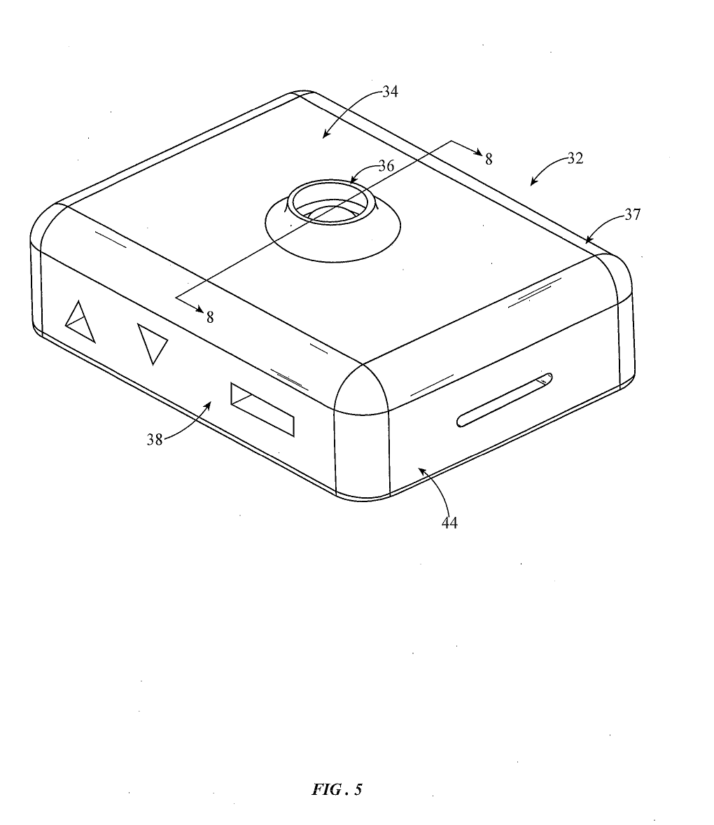

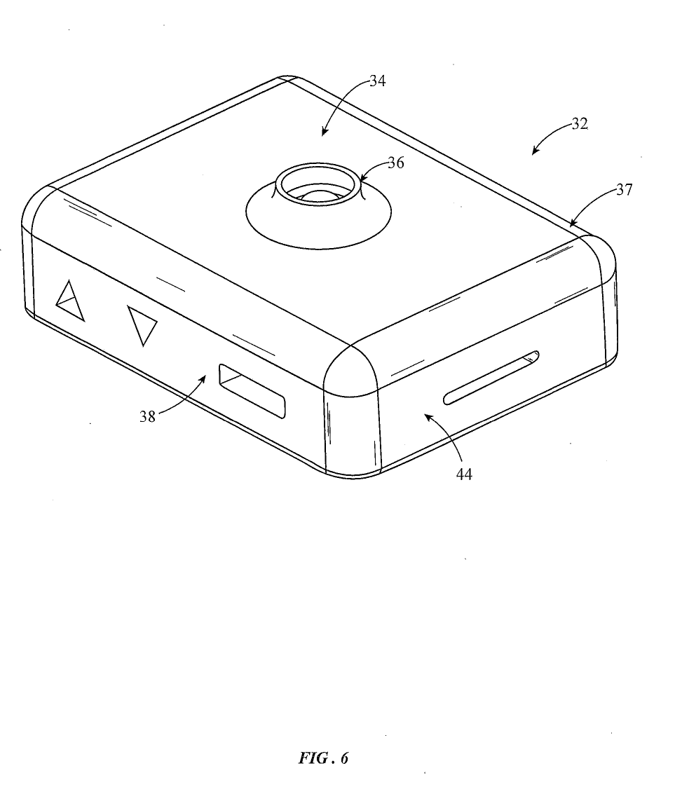

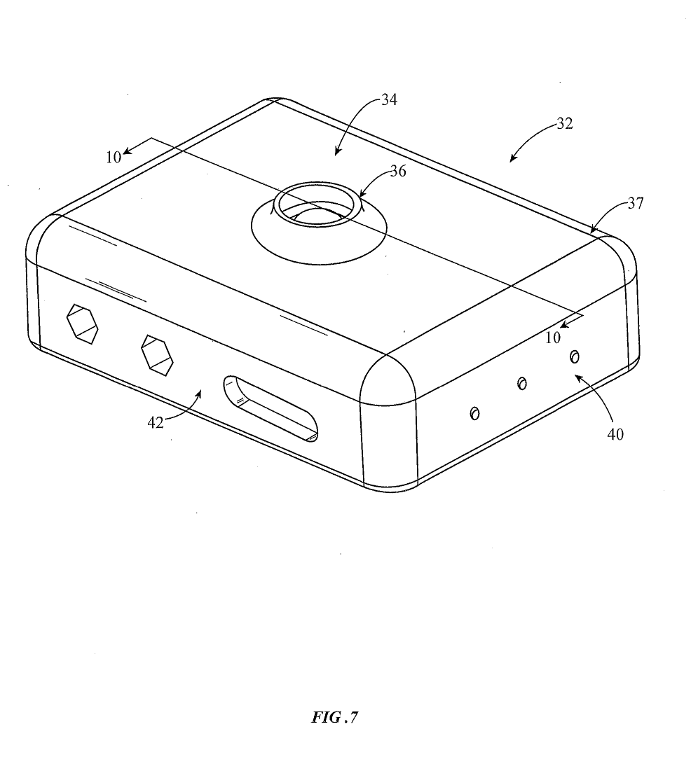

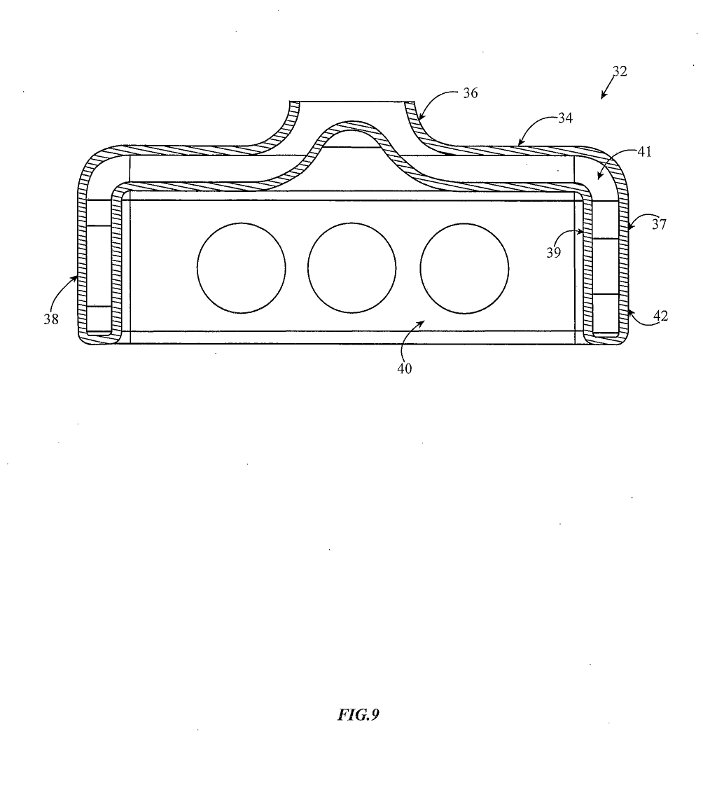

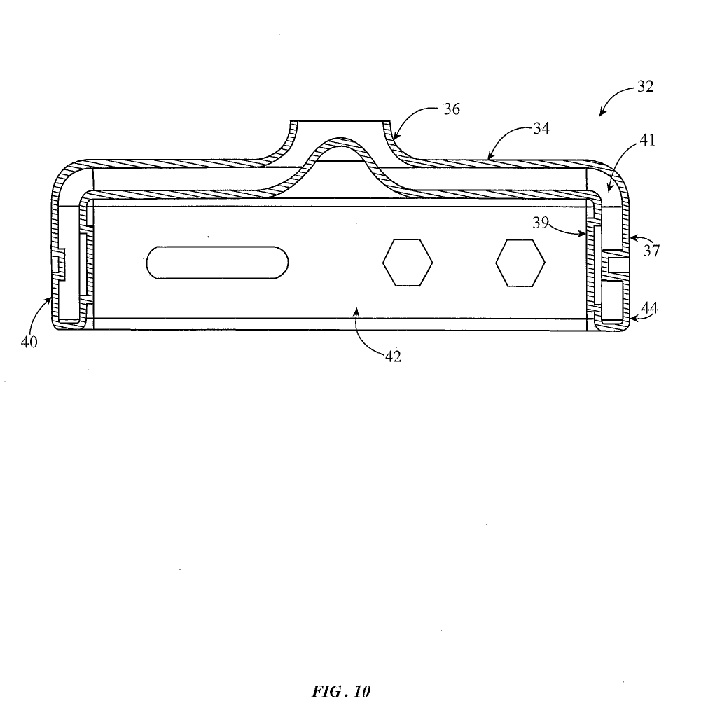

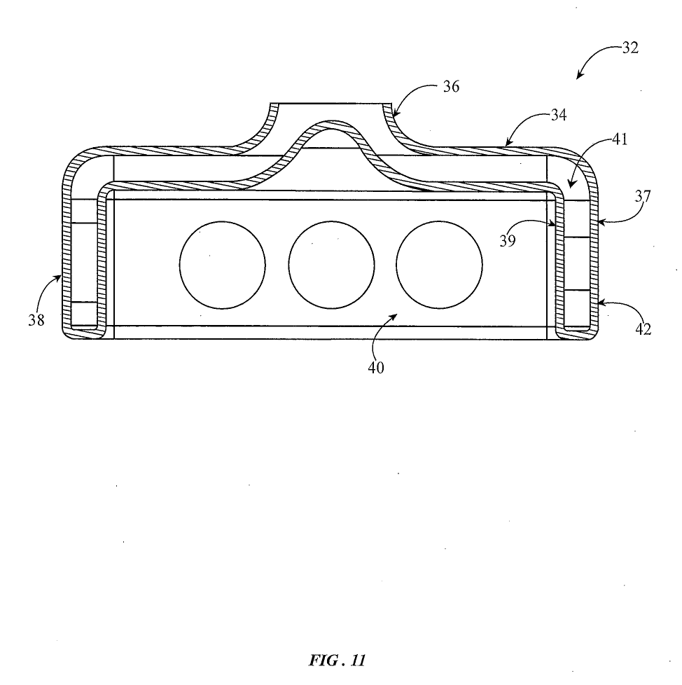

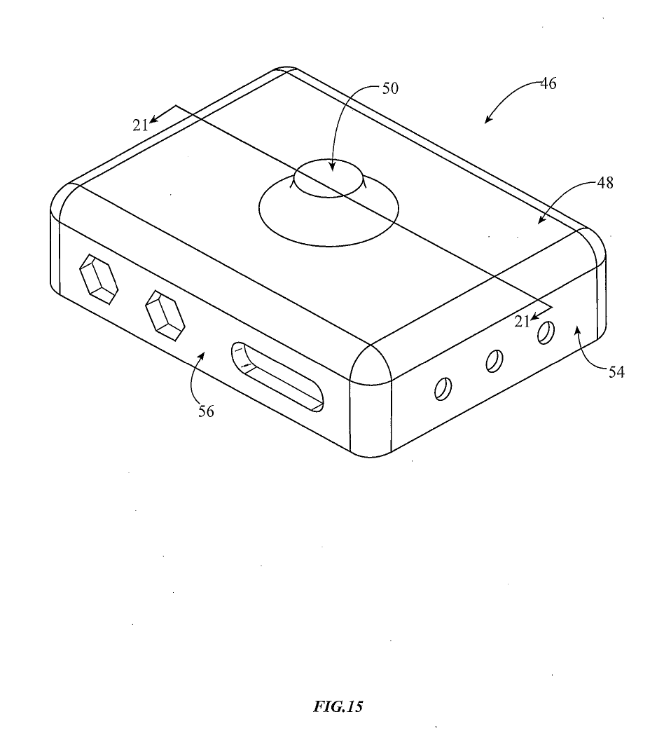

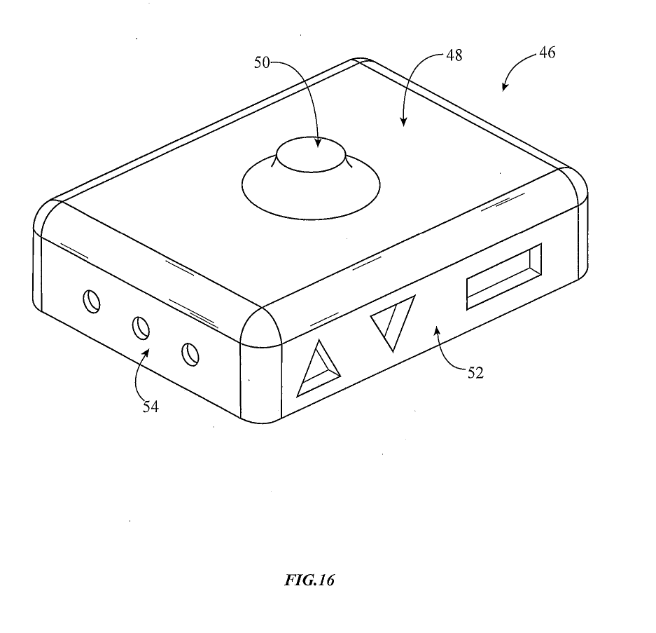

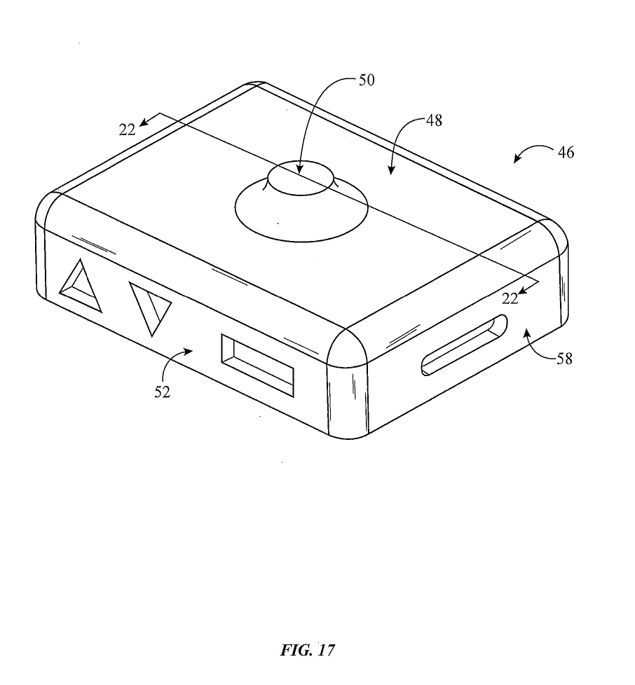

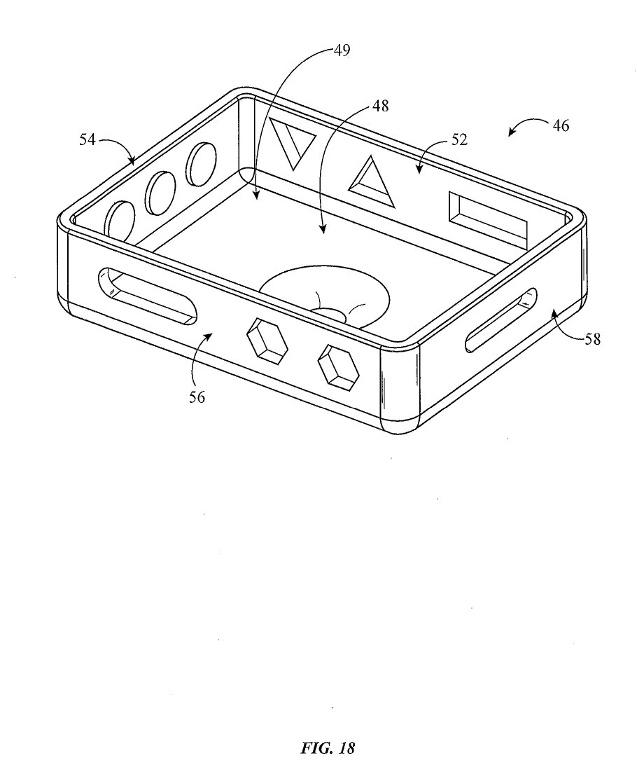

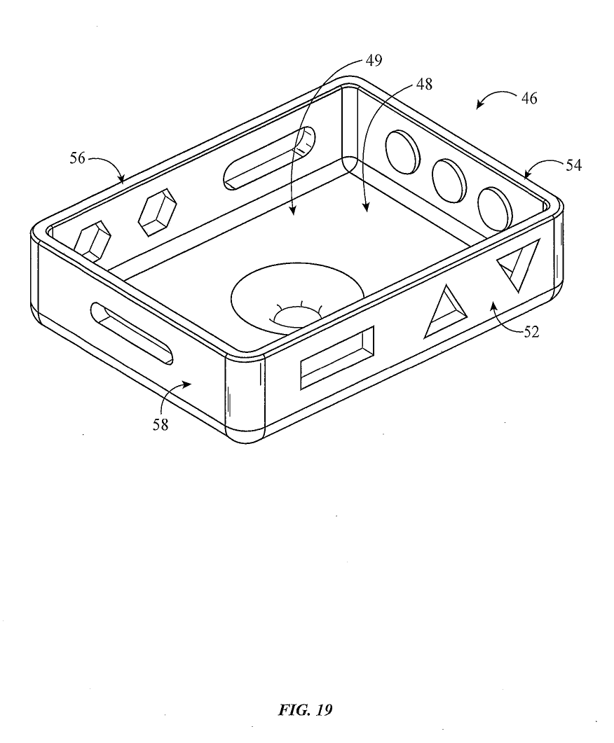

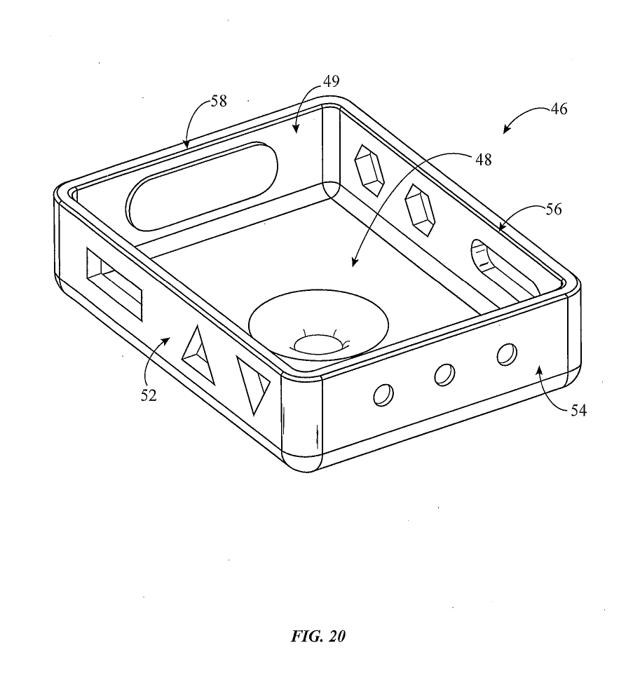

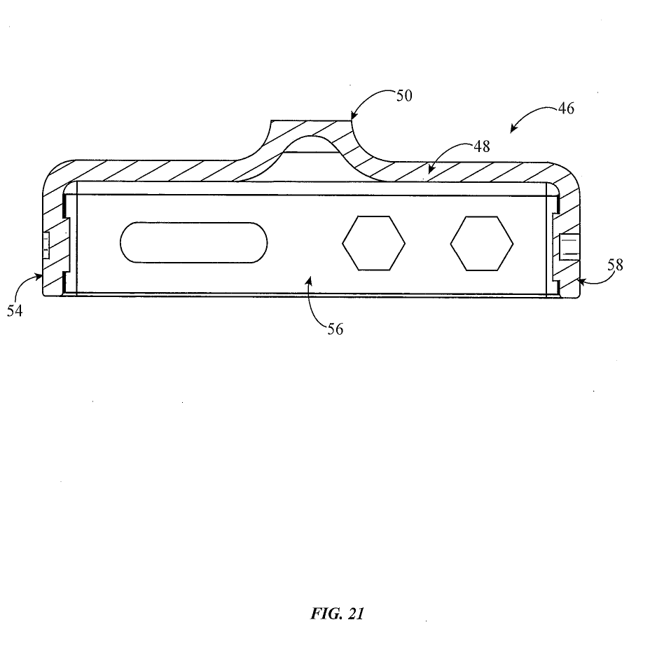

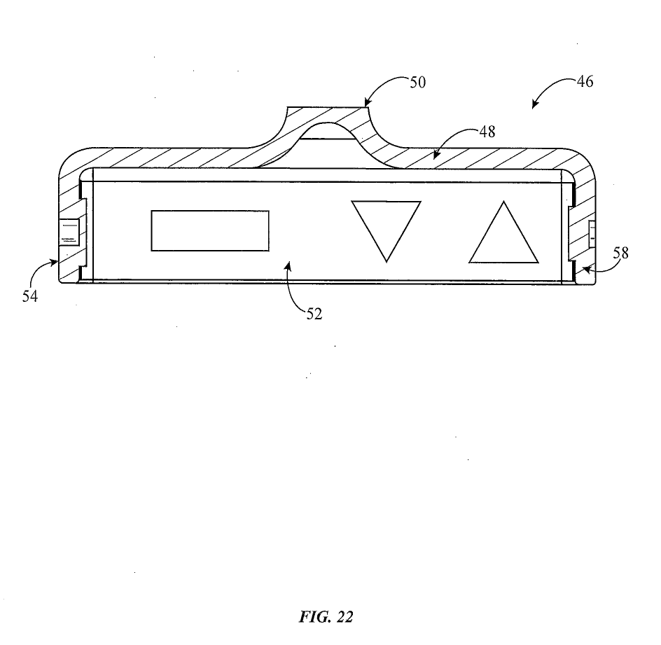

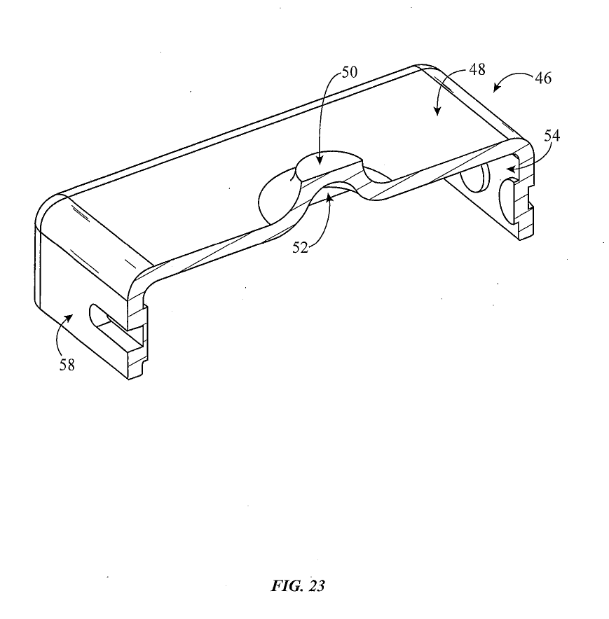

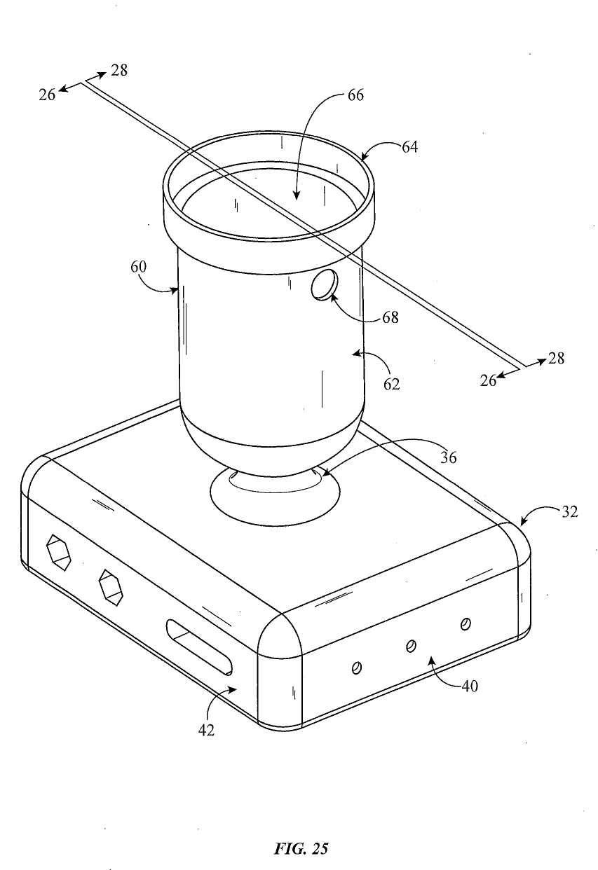

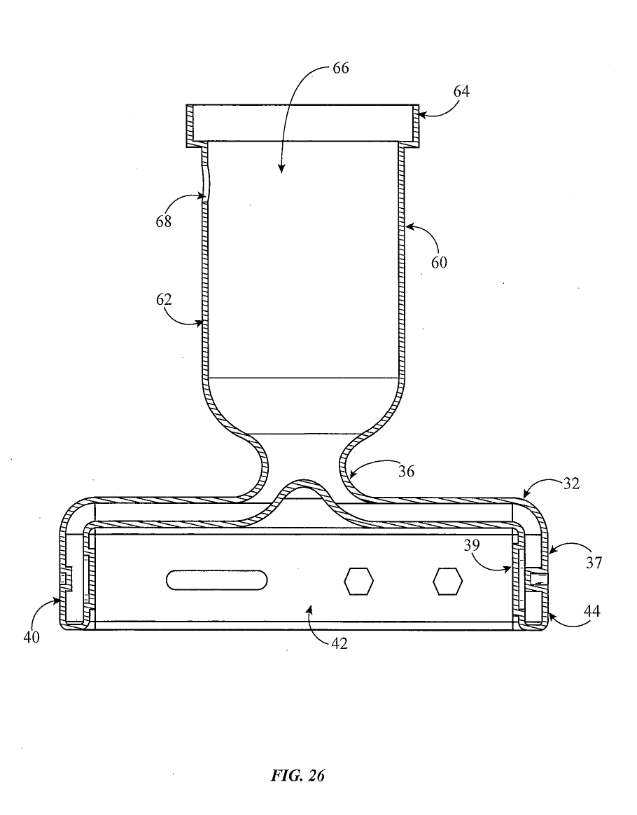

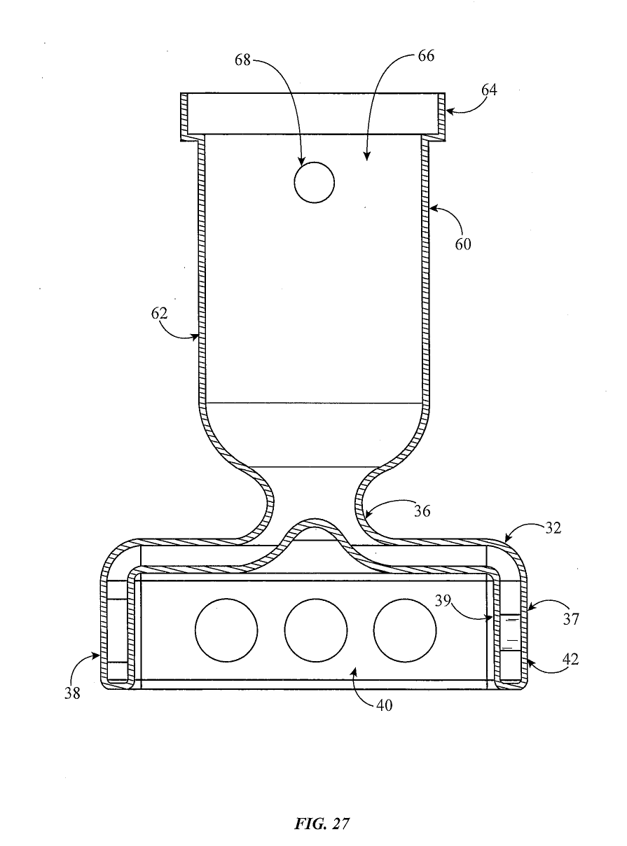

These and other embodiments are discussed below with reference to FIGS. 1-29. However, those skilled in the art will readily appreciate that the detailed description given herein with respect to these Figures is for explanatory purposes only and should not be construed as limiting.

In accordance with an embodiment, a method of this disclosure further includes using the formed 3D mold in investment casting, e.g., to form a bulk metallic glass (BMG) part. As shown in FIG. 3, a method 15 may optionally include the steps of forming the 3D mold using a 3D, AM, or layer-by-layer process as shown in step 12 of method 10 and optionally include using the formed 3D mold for investment casting as shown in step 14. In an embodiment, such steps 12 and 14 are not included in method 15. That is, it should be understood that the method 10 of forming the mold and the method 15 of utilizing the formed mold may be separate and distinct from each other, and need not require both for implementation, or the same user.

FIG. 3 shows a method 15, or a method of forming a BMG part using the formed 3D mold. The method 15 includes at least filling a 3D investment mold with molten alloy, as shown in step 24, quenching the molten alloy in the 3D investment mold, as shown in step 28, and then removing the 3D investment mold, as shown in step 30. In an embodiment, the method 15 includes removing bubbles from the molten alloy, as shown in step 26. The 3D investment mold used in method 15 is formed from a 3D, AM, or layer by layer process and is configured to form a bulk metallic glass (BMG) part. In an embodiment, to mold a BMG part, the method 15 utilizes a 3D printed investment mold that has a hollow interior (or cavity) provided between inner and outer walls; thus, the filling at 24 may include filling the hollow interior (or cavity) between the inner and outer walls of the mold with molten alloy.

The steps included in method 15 for forming a part are not limiting, and method 15 may include additional steps. For example, as shown in FIG. 3, in an embodiment, the method 15 may include melting an amorphous alloy (or metal alloy), as shown by step 16. The molten alloy is then cast into a metal or ceramic mold, where it solidifies. According to an embodiment, an amorphous or BMG alloy material may be molten in a suitable crucible (e.g., a quartz tube) by a suitable heat source and then deposited into the 3D mold. The method of melting and heat source for melting is not intended to be limited. In an embodiment, an induction coil is used to melt the amorphous alloy. The molten alloy/BMG can be poured or output from any suitable outlet of the crucible. The molten BMG may exit from the outlet and into the mold as a continuous stream or discrete droplets.

In an embodiment, the method 15 further includes heating the 3D investment mold, as shown by step 18.

In accordance with an embodiment, in method 15, the mold is filled under pressurized conditions. In one embodiment, the method 15 further includes applying a vacuum via a vacuum source (e.g., vacuum pump or evacuation pump) to at least the 3D investment mold, as shown by step 20. The molten alloy may be poured or filled at step 24 into the mold in method 15 under the vacuum.

The mold and/or molten alloy may be protected in an inert atmosphere, a reducing atmosphere or in vacuum, in order to prevent oxidation. The mold, the outlet, and/or the crucible can be in an enclosure under a vacuum (e.g., 1-10 mTorr), a reducing atmosphere (e.g., hydrogen or a mixture of hydrogen and nitrogen), or an inert atmosphere (e.g., argon, nitrogen). The enclosure can be pumped by an evacuation pump, for example.

In an embodiment, the method 15 further includes vibrating the 3D investment mold, as shown by step 22. In one embodiment, at least the mold may be vibrated during the filling at step 24. In an embodiment, the vibrations applied to the mold may enable the removal of bubbles in step 26 as the mold is filled.

In accordance with an embodiment, the vibrations applied to the 3D investment mold are ultrasonic. It should be understood, however, that the herein disclosed method 15 may utilize vibrations in frequency ranges other than ultrasonic (lower or higher frequencies or frequency ranges), and thus the use of ultrasonic vibrations herein is exemplary only and not intended to be limiting.

In one embodiment, the frequency or frequency range at which vibrations are applied to at least the 3D investment mold are selected based upon a mass of the mold and alloy and the casting temperature (e.g., to remove bubbles).

In another embodiment, the rate of filling or pour of the molten alloy into the mold may implement the removal of the bubbles at step 22 from the molten alloy.

The order and/or use of steps 16-22 as part of method 15 is not intended to be limited as shown in the illustrated flow chart of FIG. 3. That is, one or more may be used as part of method 15, and/or the succession or order of these one or more steps may be interchanged or eliminated.

In an embodiment, besides steps 24, 28, and 30, the method 15 further includes heating the 3D investment mold as shown in step 18 before filling, and applying a vacuum via a vacuum source to at least the 3D investment mold as shown in step 20, such that the molten alloy is filled under vacuum.

In an embodiment, besides steps 24, 28, and 30, the method 15 further includes ultrasonically vibrating 3D investment mold as shown in step 22 and applying a vacuum via a vacuum source to at least the 3D investment mold as shown in step 20, such that the mold is at least ultrasonically vibrated during the filling and the mold is filled under vacuum.

As previously noted, the method 15 includes removing bubbles from the molten alloy, as shown in step 26. For example, when casting amorphous alloys which contain constituents with high vapor pressures such as phosphorus, magnesium, zinc, or calcium, bubbles may form in the molten alloy. For example, when trying to cast the molten alloy quickly, or in general when trying to cast these molten alloys, if under a vacuum and/or inert environment, then bubbles may be generated, which enter the final molded/solidified part—which is not desirable as it degrades the final part.

The filling/injection process is typically performed quickly (as described previously) so that the cooling process is started as soon as possible to make the amorphous alloy/BMG part, so removing such bubbles can be challenging. Further, casting under certain environments does not necessarily reduce such problems. For example, if such parts are cast under argon, and an alloy containing a high-vapor pressure element or elements is placed into the mold, though the vapor bubbles may be suppressed, argon bubbles are typically trapped in the molten alloy when it is cast. Again, such bubbles are undesirable and cause deterioration in the quality of the final parts. Thus, in order to remove such bubbles, the step 26 of removing bubbles may, in one embodiment, include heating the 3D investment mold, as shown in step 18. In one embodiment, the step 26 of removing bubbles may include applying or maintaining the pressure of the environment of at least the mold (e.g., maintaining the mold under vacuum in an inert environment). In one embodiment, the step 26 of removing bubbles may include controlling (e.g., via controller) the rate at which the mold is filled with the molten amorphous alloy. Controlling the flow of the molten alloy may enable any gas in the mold (e.g., into the hollow interior of the mold, discussed below) to be pushed or forced out when filled under vacuum pressure. In another embodiment, the step 26 of removing bubbles may include applying the vibrations to the mold. In accordance with an embodiment, one or more of these applications (heating, pressurizing, vibrating, and/or controlling the rate) may be used to remove bubbles from the molten alloy during the filling of the mold.

In the quenching of the cast amorphous alloy and the 3D mold in step 28, in accordance with an embodiment, the filled mold is rapidly or quickly quenched after filling. Quenching is the rapid cooling of a workpiece to obtain certain material properties. It prevents low-temperature processes, such as phase transformations, from occurring. For instance, it can reduce crystallinity and thereby increase toughness of molten amorphous alloys as they are strengthened and hardened.

In an embodiment, after a complete fill of the mold is assured, the mold is immersed into a quenching bath to form a substantially amorphous atomic structure (BMG). In another embodiment, after a complete fill of the mold is assured, the mold is spray quenched. The bath or liquid used to quench the mold and alloy is not limited, and may include water or salt water, for example. Additionally, it is noted that the type of material used to form the mold can alter the quenching or cooling rate of the mold as well as the material or liquid used to quench the mold.

Further, it is noted that in accordance with an embodiment, the quenching process at step 28 in method 15 is decoupled from the filling process at step 24. That is, although the filling process of the mold in step 24 can be performed at a certain rate, it is in accordance with an embodiment that after the filling of the mold is complete, it is then quenched immediately in step 28. This allows the molten alloy to be filled or poured and confirmed to be at a steady state (with bubbles excluded) before pulling the mold so that it can be quenched to lock the molded part into the desired configuration. Also, method 15 excludes any gas process. Quenching in this manner allows for a cleaner and cosmetically desirable BMG molded part.

In one embodiment, the quenching at 28 includes quenching the molten alloy from above the melting temperature (i.e., the melting temperature to melt the amorphous alloy at 16) to the ambient temperature. In one embodiment, the quenching at 28 includes quenching the molten alloy to temperatures below glass transition at a cooling rate sufficiently fast to ensure that the bulk solidifying amorphous alloy has a substantially amorphous phase.

After quenching at 28, the bulk amorphous alloy (BMG) part is then removed. In an embodiment, the mold is removed from the molded BMG part at 30. For example, the mold may be stripped away from the cast part. However, the method of removal of the 3D mold is not intended to be limiting. The method of removal of the 3D mold may depend on the material that was used to produce the mold. In an embodiment, if the 3D mold is formed from a metal, such as steel, stainless steel or bronze, the method of removal can change. Stainless steel or bronze molds may be removed mechanically, via machining, for example. If the 3D mold is made of a material susceptible to chemical attack (e.g., bronze, copper), the mold may be removed chemically, for example, by dissolution nitric acid. A chemical used for mold dissolution would have to be chosen which selectively attacks the mold and not the part itself. When using 3D molds made of ceramic, such as quartz, the method of removal may include cracking the mold and removing it in pieces. Another process to remove the mold from the cast may include electropolishing. This process may be usable when the cast amorphous metal is not consumed in the electropolishing solution, but the mold material is. As such, it should be understood that removing the mold in 30 of method 15 can include any type, number, and/or combination of processes, so as long as the removal process does not damage the cast or molded BMG part.

In an embodiment, other post-casting finishing processes, such as polishing, can be applied to the cast BMG part after the mold is removed, although they are not discussed in detail here.

Accordingly, forming the mold using a 3D or layer-by-layer process, and/or using a 3D investment mold for molding a BMG part, provides several advantages over prior molds and methods for molding. For example, 3D printing allows for the fabrication of molds that are used for making more geometrically complex, near-net shape parts. Using 3D printing, BMG parts can be made which would be difficult or even impossible to produce with current die-cast style metal molds. 3D printed investment molds also provide lots of flexibility in terms of geometry because the geometry and shapes are unlimited (as compared to prior art methods). For example, in the prior art method of forming molds (e.g., a permanent mold made of steel) via an injection process, there are limitations in terms of draft angles. Since permanent molds must easily release from the molded part, constraints are placed on the permanent mold components and on the part design. Another limitation includes that forming features in such prior art molds requires a slide or lift, which can cost thousands of dollars and cause problems when removing the mold from the molded or cast part. Another disadvantage of lifts and sliders are that it is often difficult to get adequate heating/cooling into moving components during implementation of the method or process, and thus it is more difficult to achieve a uniform cooling rate during cooling. Mold components such as slides, cores and lifters must not interfere with each other during part extraction and part surfaces must be adequately drafted for part release. For example, for internal features that might require formation or use of a slide, it might be impossible to mold using prior art methods, since lifters are required to make the features would block each when trying to push them away from the part. Furthermore, using a 3D printed mold, the part need not have well-defined parting lines, and consequently the cast part would have no parting line witnesses. A part made in this herein disclosed manner would also require no ejection and therefore have no ejector pin witnesses. Moreover, cast part features such as straight walls can be formed with no draft.

In addition, when forming investment molds using a 3D printing process, there are no incremental costs for additional complexity. Since a 3D printed mold as disclosed herein is made layer by layer using a data file, e.g., 3D data from a CAD file, no incremental cost would be incurred making a mold more complex. Permanent mold tooling costs of the prior art, however, scale in proportion to the complexity of the part being made. A complex permanent mold has more components which are also individually more difficult to machine and assemble.

The herein disclosed method is also good for rapid prototyping. A part can be prototyped quickly since permanent mold tooling is avoided. Only the lead-time and cost to produce a single part would be required. Furthermore, many iterations of part design could be accomplished rapidly, since permanent mold tooling would not have to be modified with each iteration.

The use of a consumable 3D mold also allows for broad control of the mold temperature during the process of forming a cast part (in method 15). Since the mold itself need only be used once, the mold can be heated to any temperature within the operating limits of the mold material (e.g., as noted in 18 in method 15). Heating of the mold may be performed without regard to the long-term damage (e.g., which typically might be caused to the mold by holding it at elevated temperature). Even a reaction may take place between the amorphous alloy and the mold material at the interface without causing substantial problems with regards to the quality of the cast BMG part when using the herein disclosed 3D printed mold. While a reaction between the mold and amorphous metal should be minimized to prevent contamination of the amorphous metal, this would not pose a problem for a single-use mold. A permanent mold of the prior art, on the other hand, would be destroyed under such conditions because the mold would bond permanently to the molded part, creating a single impossible to disassemble component. Holding the mold at high temperature, even at the melt temperature of the amorphous alloy, presents significant advantages for filling the mold. The material can flow in slowly into the mold without the need for rapid cooling at the mold surface. Cooling of the entire mold-alloy apparatus can be achieved in a separate quench step. Thus filling of the mold with amorphous alloy is decoupled from the quenching of the molten alloy, allowing for better selection of filling and cooling parameters without regard for competing requirements. It may be preferable in other instances to maintain the mold at room temperature, and allow the quenching of the alloy to occur simultaneously with the filling.

Furthermore, for investment casting of amorphous metals or alloys, high thermal conductivity investments are required so that heat can be conducted rapidly from the part during quenching of the filled mold. Typical investment molds made of loosely bonded ceramic compounds have poor thermal conductivity and therefore are not well-suited for use with amorphous metals. 3D printed metal molds, however, have relatively high thermal conductivities since they are full and metal. A ceramic 3D printed mold would also be fully dense.

Moreover, 3D printed molds as disclosed herein allow for tight tolerances in molds as well as the cast BMG part made using a 3D printed mold. The tolerances of the final part will be as good as the 3D printed part. 3D printed parts may be superior to other investment casting processes.

It should be understood that although 3D printing provides such advantages, devices or methods used in prior art processes may be used along with the disclosed 3D printing process of the molds. For example, in an embodiment, supports for slope printing may be provided. As an example, when utilizing DMLS techniques to make a steel mold, supports for forming horizontal surfaces may be provided so that such surfaces of the mold are supported as they are built layer-by-layer and any possibility of the structure falling is substantially reduced and/or eliminated. In an embodiment, the part or mold may be tipped or tilted at an angled orientation (e.g., 45 degrees) while printing. In one embodiment, the mold is printed with movable or slidable parts. In one embodiment, the cast part is machined and/or subject to finishing processes after the mold is removed.

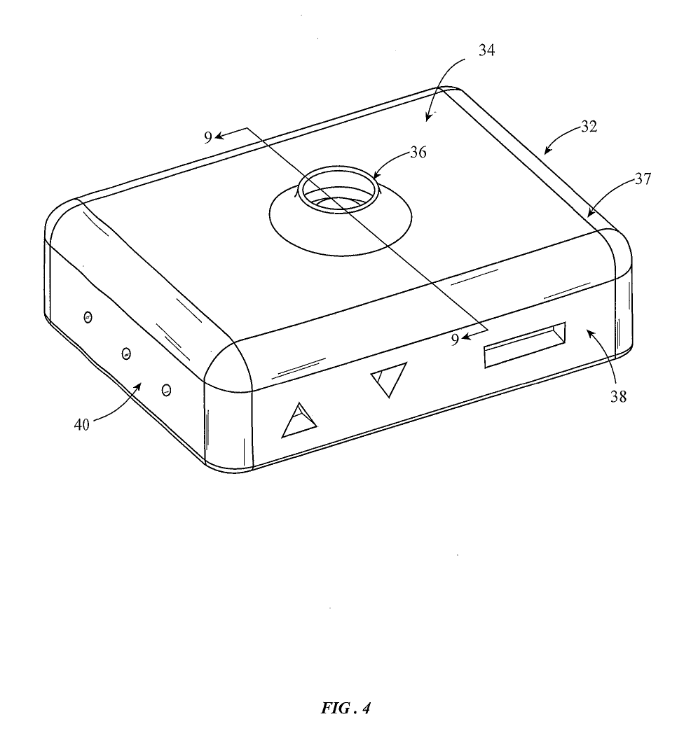

Referring now to the other Figures, FIGS. 4-13 show an exemplary investment mold 32 formed from 3D printing, as noted by method 10, in accordance with an embodiment of this disclosure. The mold 32 is formed by a layer-by-layer construction process and configured for receipt of a molten alloy having a composition configured to form a bulk metallic glass (BMG) on cooling. In an embodiment, mold 32 is configured to form a part (e.g., housing) of an electronic device. The mold 32 has negative features in comparison to those (positive) features desired in the final part that is molded via amorphous alloy using the mold 32.

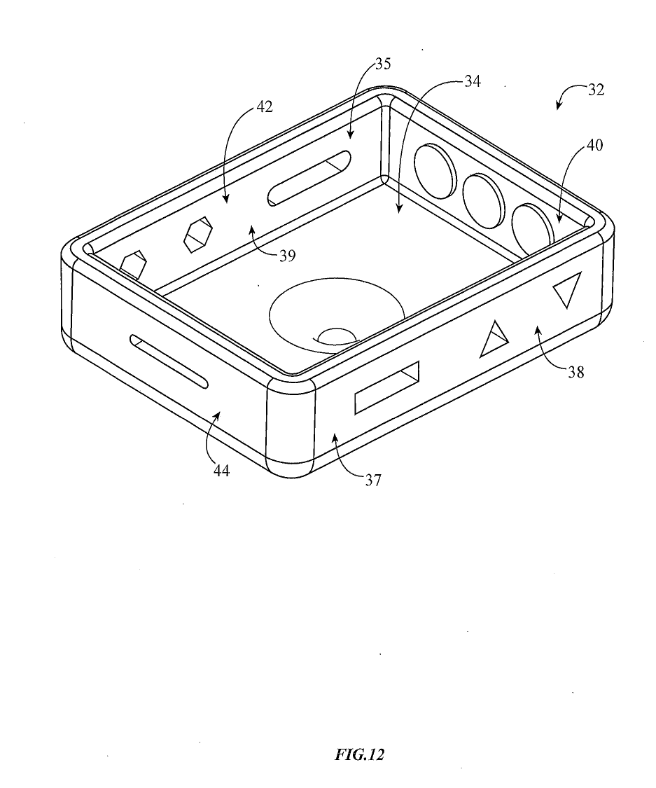

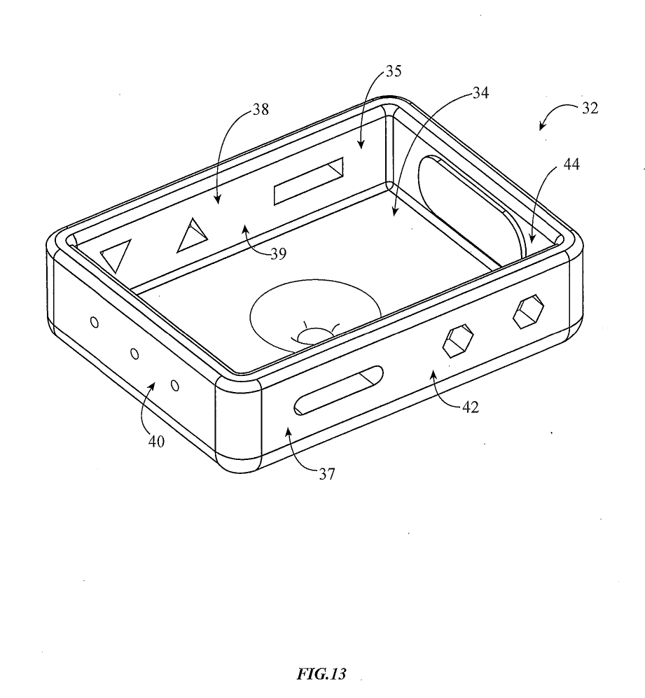

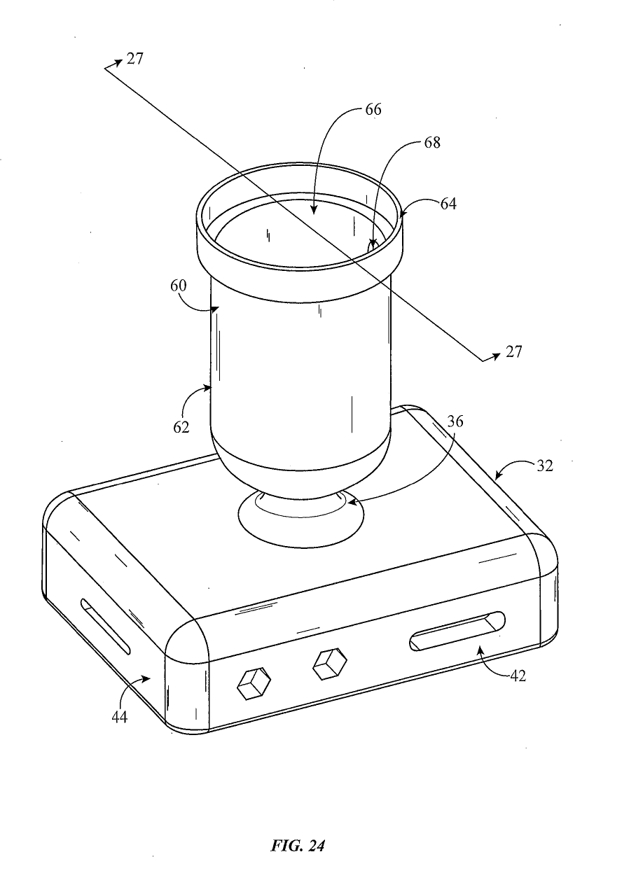

As shown, the mold 32 includes a top side 34 which may include a seat or connector portion 36 therein (e.g., for attachment of another part, such as funnel, as shown in FIGS. 24-27). The mold 32 may include an interior portion 35, as seen in FIGS. 12 and 13, for example. The exemplary mold 32 also includes a first side 38, a second side 40, a third side 42, and a fourth side 44. As seen in FIGS. 4-7, for example, each side 38-42 can include different features or designs thereon. Such designs can correlate to features on an electronic device, or to be added to an electronic device (e.g., via insertion through a portion of the final molded part), such as buttons (volume, control, and/or power buttons) or ports. Exemplary ovular, circular, triangular, and/or polygonal features—which may take the form of openings or holes—are shown in FIGS. 4-13, for example. Accordingly, it should be understood that the one or more shapes, patterns, and designs in or on the mold 32 as shown in these Figures is exemplary only.

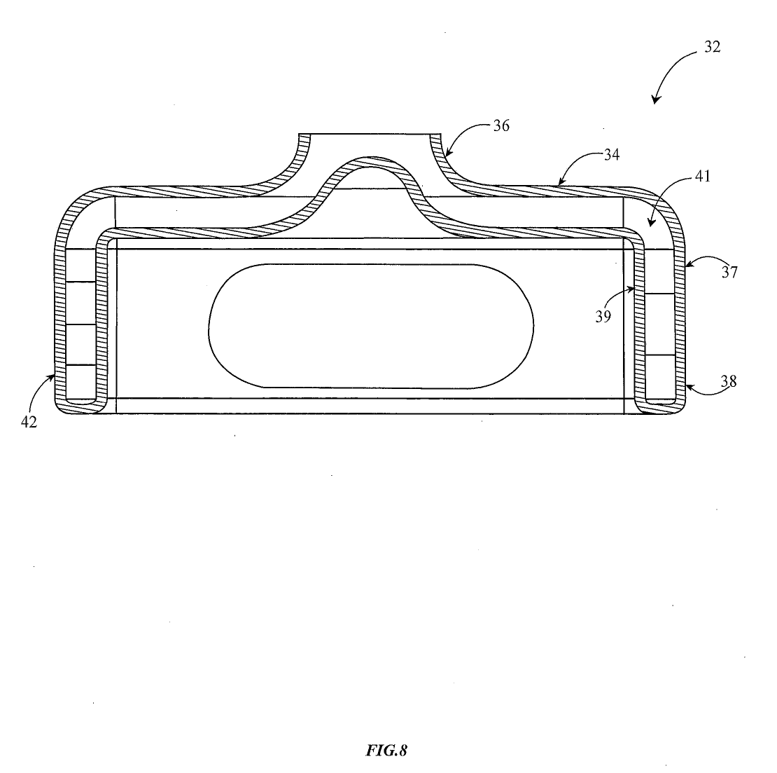

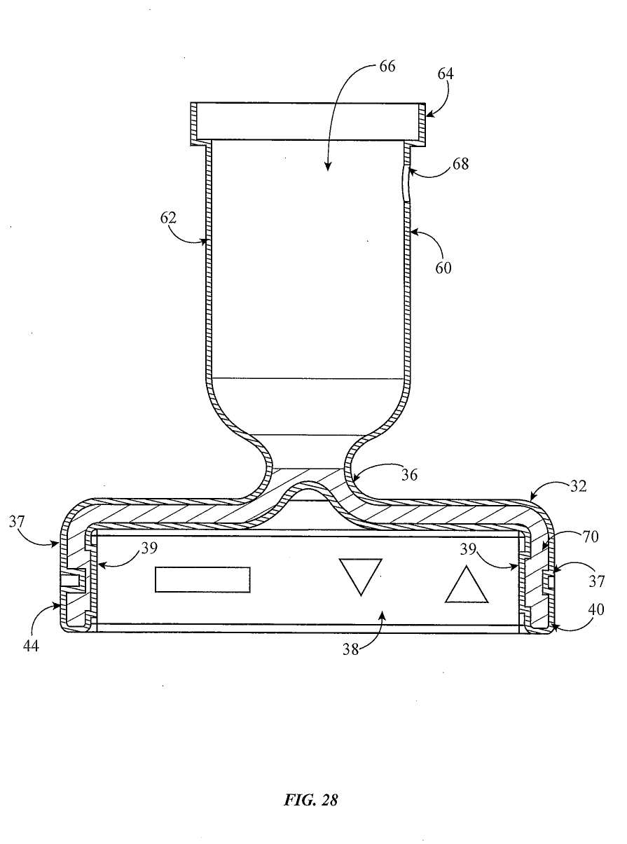

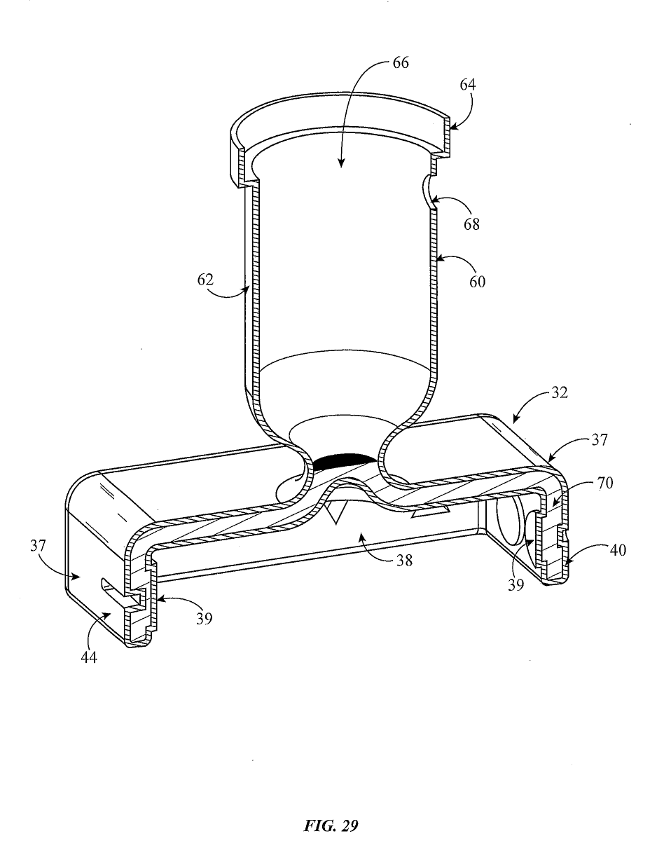

As seen in FIGS. 8-11, for example, the sides 38, 40, 42, and 44 may include an outer wall 37 and an inner wall 39 that form a hollow interior portion 41 (or cavity) therebetween. This hollow interior portion 41 (or cavity) may be configured to receive molten amorphous alloy, for example, to mold the desired BMG part. In an embodiment, the seat or connector portion 36 may be a port, for example, for receiving and directing the molten amorphous alloy in between the outer and inner walls 37, 39 of the mold 32 so that the BMG part can be cast. An example of a molten alloy 70 in between the outer and inner walls 37, 39 of the mold 32 after filling the mold 32 is shown in FIGS. 28-29, for example.

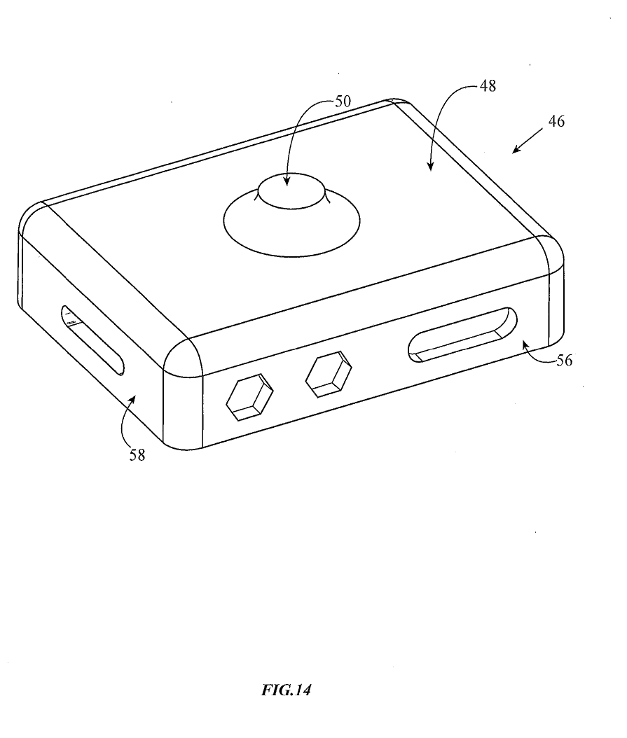

FIGS. 14-23 show an exemplary molded or casted part 46 formed using the 3D investment mold 32 of FIGS. 4-13 in accordance with an embodiment. The method 15 may be used to form the molded/casted part 46, for example. The part 46 includes a top side 48, molded portion 50, a first side 52, a second side 54, a third side 56, and a fourth side 58. As can be viewed, the top side 48 and molded portion 50 have a shape that corresponds to hollow interior 41 (or cavity) in between the outer and inner walls 37 and 39 of the top side 34 and connector portion 36, respectively. Further, the sides 52-58 of the part 46 correspond to a shape formed in the hollow interior 41 (or cavity) in between the outer and inner walls 37 and 39 of the sides 38-44 of the mold 32, respectively. The molded part 46 includes openings or holes that correspond to the exemplary ovular, circular, triangular, and/or polygonal features of the mold shown in FIGS. 4-13, for example. The molded part 46 includes one or more positive shapes, patterns, and designs corresponding to the negative of the mold 32.

FIGS. 24-27 show the mold 32 of FIGS. 4-13 with a funnel 60 attached to its seat or connector portion 32 in accordance with an embodiment of this disclosure. The funnel shape is either printed onto the mold 32 integrally therewith, or made separately and attached to the inlet 36 of the mold 32 afterwards. That is, the funnel 60 can be printed separately or along with the 3D mold 32, using a 3D, AM, or layer by layer construction process.

The funnel 60 as shown includes a body 62 with a lip 64. The body 62 has an internal receiving area 66 which may be shaped or formed in a manner such that it is configured for receipt of at least a portion of a crucible tube, for example (e.g., a tube for melting an alloy using a heat source). The internal receiving area 66 can be hollow, for example. The funnel 60 allows for the molten metal to be poured into the mold without spilling any material. This configuration also allows for heating and immediate filling of the molten alloy material into the mold 32 once the molten alloy is at a desired temperature, for example, so that substantial heat is not lost by the molten alloy as it is moved into or as it fills the mold 32. A small lip or flange may also be added to mate the mold 32 with a crucible which contains the alloy prior to casting.

In an embodiment, the funnel 60 may also have a venting hole 68 or duct to alloy the atmosphere within the funnel, above the level of the molten alloy to equilibrate with the ambient environment rapidly.

FIGS. 28-29 show cross sectional views of the mold and funnel of FIG. 24-27 when filled with molten alloy. The hollow interior 41 (or cavity) of the mold 32 can be filled with the molten alloy (e.g., filled as noted at 24 in method 15) and immediately quenched at 28 thereafter.

A 3D investment mold as disclosed herein, like mold 32, for example, includes printed features that enable the formation of complex three-dimensional parts or structures in a part that is molded using the mold. The mold layers can be printed layer-by-layer such that the mold has corresponding features to form such parts or structures in the molded part. The detailed, complex parts or structures may include any number of shapes, patterns, or designs in or on the molded part, including, but not limited to one or more: undercut features, overhangs, micro-parts or micro-patterns, recesses, openings, holes, and bezels, and their size and shapes are not limited. The mold may include these features within its interior 41 or cavity, for example, or on any of its inner or outer surfaces.

In addition, as noted, by using a 3D investment mold as disclosed herein, because of the intricate or complex details that may be printed in or on the mold, additional machining or tooling of the final molded part may be substantially reduced, substantially limited, and/or substantially eliminated entirely, because the amorphous alloy (or other meltable material) can be poured or injected into the mold (e.g., into the interior or cavity) and fill the space to form the detailed or complex features (e.g., undercuts, overhangs, etc.) in the molded part.

Accordingly, as described and shown in the Figures, this disclosure provides a method including forming a 3D investment mold using a layer-by-layer construction for receipt of a molten alloy having a composition configured to form a bulk metallic glass (BMG) on cooling. Using a layer-by-layer process to form the disclosed 3D investment mold results in minimal, substantially close to zero, or zero waste when printing the mold. Costs for forming molds may be more easily determined as well. 3D printing molds as disclosed herein provides on-demand and custom manufacturing with regards to the molds, as well as the final molded parts themselves (the parts that are molded using the printed molds). That is, if it desired that a feature or part of a molded part, e.g., of an electronic device, is altered or changed or customized, the printing of the investment mold can be altered or changed to accommodate such features.

It also provides a method of using the 3D investment mold. The method may include filling a 3D investment mold formed by a layer-by-layer construction process with molten alloy; quenching the molten alloy in the 3D investment mold, and then removing the 3D investment mold from the quenched, molded alloy. The 3D investment mold is configured to form a bulk metallic glass (BMG) part that may be part of an electronic device. The method may also include removing bubbles from the molten alloy, e.g., via vibrating the mold.

A method in accordance with an embodiment of this disclosure may include supplying molten amorphous alloy to a mold comprising a layer-by-layer construction, and removing the BMG product from the mold after cooling of the molten amorphous alloy. The mold may have a cavity between two walls for receiving the molten amorphous alloy therein. The mold may be vibrated and/or quenched during the process as well.

In accordance with an embodiment, the 3D investment mold includes at least one portion therein formed via the layer by layer construction process configured to form at least one undercut or overhang feature in the bulk metallic glass (BMG) part. Accordingly, in use, the filling of the 3D investment mold during the process or method may include filling the 3D investment mold with the molten alloy to form the at least one undercut or overhang feature in the bulk metallic glass (BMG) part (e.g., of an electronic device).

Accordingly, when using a 3D printed mold to form a molded part from amorphous alloy as disclosed herein, for example, the final features of the molded product may not only be detailed or complex (with minimal need or no need for additional machining or tooling), as previously noted above, but can also be manipulated and/or customized based on the customer's or consumer's desires, with little to no additional processing costs. Further, costs for molding each part may be more easily determined.

The disclosed 3D printing method enables the ability to use metal (or other materials) for forming a consumable mold for casting using amorphous alloys, for example, and provides a solution for challenges of casting molten metal and BMG parts. In particular, this disclosure may be useful when casting a precious metal BMG, including those which have the aforementioned issues (i.e., bubbles).

Alternatively, using conventional investment materials in molds that receive molten amorphous alloys as disclosed herein include problems of heat flow therein since they may act as insulators and can lack the ability to form complex three-dimensional parts or structures in the mold which have more complex internal features. Further, in contrast to prior molds and methods, whose resultant cast parts were subject to crystallization because of at least the time involved in using conventional molds, the herein disclosed method 15 also allows for fast quenching of parts. The filling and quenching processes of BMG are decoupled. The disclosed methods are more flexible than conventional processes.

Though the embodiments discussed herein are made with reference to FIGS. 1-29, those skilled in the art will readily appreciate that the detailed description given herein with respect to these Figures is for explanatory purposes only and should not be construed as limiting.

Further, it should be understood that the terms used herein, including molten alloy, molten metal, molten amorphous alloy, amorphous alloy, BMG, and the like are not intended to be limiting, but also understood to refer to bulk-solidifying amorphous alloys, or bulk metallic glasses (“BMG”) that are used in the herein disclosed mold to form BMG parts.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A method comprising:
forming a 3D investment mold using a layer-by-layer construction for receipt of a molten alloy having a composition configured to form a bulk metallic glass (BMG) on cooling,
wherein the mold is configured to be filled with a molten amorphous alloy to form a housing of an electronic device.

2. The method of claim 1, wherein the 3D investment mold comprises a hollow interior between inner and outer walls, and wherein the hollow interior is configured to receive the molten amorphous alloy for molding the molten amorphous alloy between the inner and outer walls.

3. The method of claim 1, wherein the layer-by-layer construction comprises a selective laser sintering (SLS) technique.

4. The method of claim 1, wherein the layer-by-layer construction comprises a direct metal laser sintering (DMLS) technique.

5. The method of claim 1, wherein the layer-by-layer construction comprises a selective laser melting (SLM) technique.

6. The method of claim 1, wherein the layer-by-layer construction comprises an electron beam melting (EBM) technique.

7. The method of claim 1, wherein a layer of the layer-by-layer construction is deposited from a plurality of outlets.

8. The method of claim 1, further comprising, after forming, filling the formed 3D investment mold with the molten amorphous alloy;
removing bubbles from the molten amorphous alloy;
quenching the molten amorphous alloy in the 3D investment mold, and then
removing the 3D investment mold from the molded housing of the electronic device.

9. A method comprising:
filling a 3D investment mold formed by a layer-by-layer construction process with molten alloy;
quenching the molten alloy in the 3D investment mold, and then
removing the 3D investment mold from the quenched, molded alloy,
wherein the 3D investment mold is configured to form a bulk metallic glass (BMG) part that is part of an electronic device.

10. The method of claim 9, further comprising removing bubbles from the molten alloy.

11. The method of claim 9, further comprising vibrating the 3D investment mold, and wherein the mold is at least vibrated during the filling.

12. The method of claim 11, wherein the vibrations applied to the 3D investment mold are ultrasonic.

13. The method of claim 9, further comprising applying a vacuum via a vacuum source to at least the 3D investment mold, and wherein the molten alloy is filled under vacuum.

14. The method of claim 9, further comprising heating the 3D investment mold.

15. The method of claim 9, further comprising heating the 3D investment mold before filling and applying a vacuum via a vacuum source to at least the 3D investment mold, wherein the mold is filled with the molten alloy under vacuum.

16. The method of claim 9, further comprising vibrating the 3D investment mold and applying a vacuum via a vacuum source to at least the 3D investment mold, wherein the mold is at least vibrated during the filling and wherein the mold is filled with the molten alloy under vacuum.

17. The method of claim 16, wherein the vibrations applied to the 3D investment mold are ultrasonic.

18. The method of claim 9, wherein the 3D investment mold comprises a hollow interior provided between inner and outer walls, and wherein the hollow interior is configured to receive the molten alloy when filling the mold with the molten alloy between the inner and outer walls.

19. The method of claim 9, wherein the 3D investment mold includes at least one portion therein formed via the layer by layer construction process configured to form at least one undercut or overhang feature in the bulk metallic glass (BMG) part, and wherein the filling of the 3D investment mold includes filling the 3D investment mold with the molten alloy to form the at least one undercut or overhang feature in the bulk metallic glass (BMG) part of the electronic device.

20. The method of claim 9, wherein the removing of the 3D investment mold comprises mechanically or chemically removing the 3D investment mold from the quenched, molded alloy.

21. The method of claim 9, further comprising polishing the BMG part after removing the 3D investment mold.

22. A method comprising:
supplying molten amorphous alloy to a mold comprising a layer-by-layer construction, the molten amorphous alloy having a composition configured to form a bulk metallic glass (BMG) product on cooling, and
removing the BMG product from the mold after cooling of the molten amorphous alloy,
wherein the mold comprises a cavity between two walls for receiving the molten amorphous alloy therein.

23. The method of claim 22, wherein the BMG product is a part of an electronic device.

24. The method of claim 23, wherein the mold includes at least one portion therein formed via the layer by layer construction process configured to form at least one undercut or overhang feature in the BMG product part, and wherein the supplying of the mold includes supplying the mold with the molten amorphous alloy to form the at least one undercut or overhang feature in the BMG product of the electronic device.

25. The method of claim 22, further comprising vibrating the mold.
